(19) United States
(12) Patent Application Publication
(10) Pub. No.: US 2023/0219216 A1
(43) Pub. Date: Jul. 13, 2023

(54) DRIVE DEVICE COMPRISING A DRIVE COMPONENT THAT HAS A LIGHT-STABILISED DYNAMIC MATERIAL, AND ROBOT

(71) Applicant: KUKA Deutschland GmbH, Augsburg (DE)

(72) Inventor: Andreas Keibel, Augsburg (DE)

(73) Assignee: KUKA Deutschland GmbH, Augsburg (DE)

(21) Appl. No.: 18/003,602

(22) PCT Filed: Jun. 22, 2021
(86) PCT No.: PCT/EP2021/066937

§ 371 Date: Dec. 28, 2022

(30) Foreign Application Priority Data
Jun. 29, 2020 (DE) 10 2020 208 063.1

(51) Int. Cl. B25J 9/12; B25J 19/00; H02K 7/10

(52) U.S. Cl. CPC B25J 9/126; B25J 19/0004; H02K 7/10

(57) ABSTRACT

A drive device including at least one motor and at least one additional drive component from the group of a transmission, a torque converter, a clutch and/or a brake, wherein the at least one motor and/or the at least one additional drive component includes a control means which changes the torque transmission and which includes at least one illuminant and a material that influences the torque transmission and that includes at least one light-stabilized dynamic material (LSDM). The control means is configured to change the torque transmission by actuating the illuminant, which radiates onto the light-stabilized dynamic material (LSDM). A robot includes at least one such drive device.

### CROSS-REFERENCE TO RELATED APPLICATIONS

This application is a national phase application under 35 U.S.C. § 371 of International Patent Application No. PCT/EP2021/066937, filed Jun. 22, 2021 (pending), which claims the benefit of priority to German Patent Application No. DE 10 2020 208 063.1, filed Jun. 29, 2020, the disclosures of which are incorporated by reference herein in their entirety.

### TECHNICAL FIELD

The invention relates to a drive device having at least one motor and at least one additional drive component from the group of a transmission, a torque converter, a clutch and/or a brake, and comprising a control device which is designed to automatically control the at least one motor. The invention also relates to a robot comprising at least one such drive device.

### BACKGROUND

WO 2015/067623 A2 describes an industrial robot comprising a robot controller which is designed and/or configured to execute a robot program, and comprising a manipulator arm with multiple links that are connected via joints, which are automated in accordance with the robot program or can be adjusted automatically in a manual mode, and comprising at least one electrical drive which can be controlled by the robot controller and which is designed to adjust at least one of the joints. The electric drive has an electric motor comprising a motor casing, a drive shaft rotatably mounted by means of at least two roller bearings, a stator fixed in the motor casing, a rotor connected to the drive shaft and rotatable in the motor casing, as well as a strain wave gearing comprising a transmission casing, a rigid outer ring with internal toothing, a flexible drive bushing with external toothing, and a shaft generator rotatable in the transmission casing and rolling on the flexible drive bushing, wherein the external toothing of the flexible drive bushing is in meshing engagement with the internal toothing of the rigid outer ring as a function of a rotational movement of the shaft generator, and wherein the rotor is mounted on the drive shaft and a first of the at least two roller bearings is arranged within the flexible drive bushing and configured to rotatably support the drive shaft in the transmission casing.

### SUMMARY

The object of the invention is to provide a drive device or a robot comprising at least one such drive device, which drive devices allow energy-saving operation in a particularly low-wear design.

The object is achieved by a drive device comprising at least one motor and at least one additional drive component from the group of a transmission, a torque converter, a clutch and/or a brake, and comprising a control device which is designed to automatically control the at least one motor, wherein the at least one motor and/or the at least one additional drive component comprises a control means which changes the torque transmission and which comprises at least one illuminant and a material that influences the torque transmission and that has at least one light-stabilized dynamic material (LSDM), wherein the control means is configured to change the torque transmission by actuating the illuminant, which radiates onto the light-stabilized dynamic material (LSDM).

The at least one additional drive component can be at least one transmission, at least one torque converter, at least one clutch and/or at least one brake. The inventive drive device can be used individually or in multiple embodiments on any device, machine or equipment to be driven.

In one possible embodiment, the device on which at least one such inventive drive device can be used particularly expediently can specifically be a robot. Accordingly, the robot may comprise a robot arm, a robot controller and at least one inventive drive device.

For example, each joint of a robot arm is usually associated with a combination of drive components, i.e., each joint of the robot arm may comprise at least one drive component of the aforementioned drive components or multiple different or similar drive components of the aforementioned drive components. For example, one joint or multiple joints of the robot arm may comprise a motor which is connected to a transmission, wherein the joint, the transmission and/or the motor can be provided with a brake. The transmission may, for example, also comprise a clutch and/or a torque converter.

The inventive control means which changes the torque transmission can generally be used in any of the devices to be used in one of the aforementioned drive components, in multiple, in particular different, drive components of the aforementioned drive components or even in all existing drive components.

In a basic embodiment, the control means which changes the torque transmission can be designed to completely permit torque transmission in a first switching state and to completely prevent torque transmission in a second switching state.

Preventing torque transmission in the case of a clutch or torque converter may be a complete disconnection so that, in such a state, no torque is transmitted at all. Alternatively, preventing torque transmission can, in a different sense, also mean blocking the torque transmission, for example in the case of a brake in which torque transmission is prevented by a shaft, which is actually intended to transmit i.e., transfer the torque, being blocked, i.e., fixed or held, so that the shaft can no longer rotate and thus no longer transmit torque.

In such a case, the torque is supported, for example, by a casing.

The control means which changes the torque transmission may comprise, for example, exactly two switching states, i.e., the states described for the complete transmission of the torque and for complete suppression of the transmission of the torque.

Alternatively, the control means which changes the torque transmission may also comprise more than two switching states; in particular, the state which transmits the torque can also change continuously or linearly and can accordingly be changed constantly. In such a case, the control means can change the magnitude of the torque to be transmitted.

The illuminant can be selectively switched on or off in order to change or switch the state of the torque transmission. However, the illuminant can also be designed to variably change the magnitude of its luminosity or brightness. The illuminant can thus be designed to be dimmable. The illuminant can then either shine more brightly, shine less brightly, or not shine.

In order to be able to influence the torque transmission by means of the at least one illuminant, a material that influences the torque transmission is inventively provided, which material comprises at least one light-stabilized dynamic material (LSDM).

Light-stabilized dynamic materials (LSDM) are already known as such. For example, in a publication (“Supporting Information File”) entitled “Light-Stabilised Dynamic Materials”, the authors Hannes A. Houck, Eva Blasco, Filip E. Du Prez, and Christopher Barner-Kowollik describe chemical compounds and compositions which comprise such properties and are already referred to among experts as “light-stabilized dynamic materials (LSDM).”

Optically activated polymers can, for example, be converted from the liquid phase into a stable solid phase by UV light. In research, these processes are already reversible in the laboratory. As soon as the light source is deactivated, the material liquefies again. Reverse processes are also already being developed in the laboratory, in which a liquid material solidifies under the effect of light.

With the aid of these photoactivatable materials, inventively, for example, novel brakes can be developed in drive technology in general and in robotics in particular, which show an incomparable low wear at least for holding tasks and reach a new dimension of availability and durability. In addition, it is possible to use significantly less brake activation energy.

The illuminant can preferably be actuated electrically. In addition, illuminants which generate light from electrical energy can preferably be used. The illuminant can therefore be actuated by supplying electrical energy to the illuminant so that it emits light, or by switching off the electrical energy so that the illuminant emits more light.

Accordingly, in the case of light-stabilized dynamic materials (LSDM), the material remains solid as long as it is irradiated with light. However, if the illuminant is switched off, i.e., the light-stabilized dynamic material (LSDM) is no longer irradiated with light, it liquefies again. Alternating between solidification and liquefaction, this process can be repeated indefinitely.

The invention generally requires a casing in which the light-stabilized dynamic material (LSDM) is present. At least one shaft or multiple shafts, which are provided for transmitting the torque, project into such a space or chamber, which is filled with the light-stabilized dynamic material (LSDM). The at least one shaft or the multiple shafts carry, and optionally the casing or space or chamber, transmission structures immersed in the light-stabilized dynamic material (LSDM). If the light-stabilized dynamic material (LSDM) is in its liquid state due to a lack of light irradiation, the transmission structures can move in the liquid and transmission of an introduced torque is no longer possible or only possible to a limited extent. If the light-stabilized dynamic material (LSDM) is in its solid state due to light irradiation, the transmission structures can no longer move therein and are thus positively connected to the solidified, i.e., now rigid, light-stabilized dynamic material (LSDM). A transmission of an introduced torque is thus possible without restriction in this state. In particular in the embodiments as a clutch or a torque converter, transition states of the light-stabilized dynamic material (LSDM) between solid and liquid can be used in order to transmit torque at a controlled level, and/or to increase or decrease the torque in a controlled manner.

The control means which changes the torque transmission may be associated with at least one brake, wherein the brake comprises a brake member which is torque-coupled to the associated motor, is rotatably mounted in a brake casing of the brake and comprises first brake transmission structures, and the brake casing comprises second brake transmission structures, wherein the first brake transmission structures are in contact with the second brake transmission structures via the material comprising the at least one light-stabilized dynamic material (LSDM) in order to control the torque transmission between the first brake transmission structures and the second brake transmission structures as a function of the light radiated by the illuminants onto the light-stabilized dynamic material (LSDM).

The rotatably mounted braking member can, for example, be part of a shaft which is to be braked in a controlled manner. The shaft can, for example, be coupled to a motor shaft of a motor, in particular a motor of a robot arm, or the shaft can be the motor shaft directly. In this respect, the rotatably mounted brake member can be designed analogously to a brake disk and may comprise the first brake transmission structures.

The first brake transmission structures are intended to be designed and arranged such that, in a liquid state of the light-stabilized dynamic material (LSDM), the first brake transmission structures permit an at least largely or even completely free rotation of the brake member and, in a solid state of the light-stabilized dynamic material (LSDM), bring about an at least largely or completely positive connection between the first brake transmission structures and the solid light-stabilized dynamic material (LSDM). In this respect, the first brake transmission structures can be formed, for example, by web-like, rib-like, wave-like and/or blade-like projections.

The second brake transmission structures can be arranged in the inner walls of the brake casing. In this respect, they extend into the light-stabilized dynamic material (LSDM) analogously to the first brake transmission structures. The second brake transmission structures are also intended to be designed and arranged such that, in a liquid state of the light-stabilized dynamic material (LSDM), the second brake transmission structures permit an at least largely or even completely free rotation of the brake member and, in a solid state of the light-stabilized dynamic material (LSDM), bring about an at least largely or completely positive connection between the second brake transmission structures and the solid light-stabilized dynamic material (LSDM). In this respect, the second brake transmission structures can be formed, for example, by web-like, rib-like, wave-like and/or blade-like projections.

The control means which changes the torque transmission may be associated with at least one clutch of the drive device, in particular a clutch of a robot, wherein the clutch comprises a first clutch member which is torque-coupled to the associated motor, is rotatably mounted in a clutch casing of the clutch and comprises first clutch transmission structures, and said clutch comprises a second clutch member rotatably mounted in the clutch casing of the clutch and comprising second clutch transmission structures, wherein the first clutch transmission structures are in contact with the second clutch transmission structures via the material comprising the at least one light-stabilized dynamic material (LSDM) in order to control the torque transmission between the first clutch transmission structures and the second clutch transmission structures as a function of the light radiated by the illuminants onto the light-stabilized dynamic material (LSDM).

The first and second clutch transmission structures are intended to be designed and arranged such that, in a liquid state of the light-stabilized dynamic material (LSDM), the first and second clutch transmission structures permit an at least largely or even completely free rotation of the first and second clutch members and, in a solid state of the light-stabilized dynamic material (LSDM), bring about an at least largely or completely positive connection between the first and second clutch transmission structures and the solid light-stabilized dynamic material (LSDM). In this respect, the first and second clutch transmission structures can be formed, for example, by web-like, rib-like, wave-like and/or blade-like projections.

The control means which changes the torque transmission may be associated with at least one torque converter of the drive device, in particular a torque converter of a robot, wherein the torque converter comprises a first converter member which is torque-coupled to the associated motor, is rotatably mounted in a converter casing of the torque converter and comprises first converter transmission structures, and said converter comprises a second converter member rotatably mounted in the converter casing of the torque converter and comprising second converter transmission structures, and the converter casing comprises third converter transmission structures, wherein the first converter transmission structures are in contact with the second converter transmission structures and third converter transmission structures via the material comprising the at least one light-stabilized dynamic material (LSDM) in order to control the torque transmission between the first converter transmission structures and the second converter transmission structures as a function of the light radiated by the illuminants onto the light-stabilized dynamic material (LSDM).

The first, second and third converter transmission structures are intended to be designed and arranged such that, in a liquid state of the light-stabilized dynamic material (LSDM), the first, second and third converter transmission structures permit an at least largely or even completely free rotation of the first and second converter members and, in a solid state of the light-stabilized dynamic material (LSDM), bring about an at least largely or completely positive connection between the first, second and third converter transmission structures and the solid light-stabilized dynamic material (LSDM). In this respect, the first, second and third converter transmission structures can be formed, for example, by web-like, rib-like, wave-like and/or blade-like projections.

The control means which changes the torque transmission may be associated with at least one transmission of the drive device, in particular a transmission of a robot, wherein the transmission comprises a transmission member which is torque-coupled to the associated motor, is rotatably mounted in a transmission casing of the transmission and comprises first transmission transmission structures, and at least one transmission stage comprising second transmission transmission structures is arranged in the transmission casing, wherein the first transmission transmission structures are in contact with the second transmission transmission structures via the material comprising the at least one light-stabilized dynamic material (LSDM) in order to control the torque transmission between the first transmission transmission structures and the second transmission transmission structures as a function of the light radiated by the illuminants onto the light-stabilized dynamic material (LSDM).

The first and second transmission transmission structures are intended to be designed and arranged such that, in a liquid state of the light-stabilized dynamic material (LSDM), the first and second transmission transmission structures permit an at least largely or even completely free rotation of the respective transmission member and, in a solid state of the light-stabilized dynamic material (LSDM), bring about an at least largely or completely positive connection between the first and second transmission transmission structures and the fixed light-stabilized dynamic material (LSDM). In this respect, the first and second transmission transmission structures can be formed, for example, by web-like, rib-like, wave-like and/or blade-like projections.

The control means which changes the torque transmission may be associated with the at least one motor, wherein the at least one motor comprises a torque member which is torque-coupled to the associated motor shaft, is rotatable in a motor casing of the motor, and comprises first motor torque transmission structures, and the motor shaft comprises second motor torque transmission structures, wherein the first motor torque transmission structures are in contact with the second motor torque transmission structures via the material comprising the at least one light-stabilized dynamic material (LSDM) in order to control the torque transmission between the first motor torque transmission structures and the second motor torque transmission structures as a function of the light radiated by the illuminants onto the light-stabilized dynamic material (LSDM).

The first and second motor torque transmission structures are intended to be designed and arranged such that, in a liquid state of the light-stabilized dynamic material (LSDM), the first and second motor torque transmission structures permit an at least largely or even completely free rotation of the respective torque member and, in a solid state of the light-stabilized dynamic material (LSDM), bring about an at least largely or completely positive connection between the first and second motor torque transmission structures and the solid light-stabilized dynamic material (LSDM). In this respect, the first and second motor torque transmission structures can be formed, for example, by web-like, rib-like, wave-like and/or blade-like projections.

In all embodiments of the drive components, the at least one illuminant can be an LED arranged within the brake casing, within the clutch casing, within the converter casing, within the transmission casing and/or within the motor casing, which is electrically actuated from the outside.

The illuminants, in particular the LEDs, can be arranged in groups such as lines, rows or clusters and can be adapted, in particular with regard to their number, positions and arrangements, to the respective transmission structures, i.e., the first and second brake transmission structures, the first and second clutch transmission structures, the first, second and third converter transmission structures, the first and second transmission transmission structures and/or the first and second motor torque transmission structures.

In all embodiments of the drive components, the at least one illuminant can be an LED arranged outside of a light-transmissive brake casing, outside of a light-transmissive clutch casing, outside of a light-transmissive converter casing, outside of a light-transmissive transmission casing and/or outside of a light-transmissive motor casing, wherein the light emitted by the at least one LED radiates onto the light-stabilized dynamic material (LSDM) from the outside.

In the case of external illuminants, in particular LEDs, these can be arranged in groups such as lines, rows or clusters and can be adapted, in particular with regard to their number, positions and arrangements, to the respective transmission structures, i.e., the first and second brake transmission structures, the first and second clutch transmission structures, the first, second and third converter transmission structures, the first and second transmission transmission structures and/or the first and second motor torque transmission structures.

If the illuminants, in particular the LEDs, are arranged outside of the light-stabilized dynamic material (LSDM), it is no longer necessary to run electrical lines to the light-stabilized dynamic material (LSDM). Any passages that are otherwise necessary from the outside to the inside for the electrical lines can also be dispensed with.

In all embodiments of the drive components, the first and second brake transmission structures, the first and second clutch transmission structures, the first, second and third converter transmission structures, the first and second transmission transmission structures and/or the first and second motor torque transmission structures may comprise projections, in particular blade-shaped or wave-shaped projections, which project into the light-stabilized dynamic material (LSDM).

Such projections can be designed to enhance a positive connection with the light-stabilized dynamic material (LSDM) in its solid state. Such projections can alternatively or additionally be designed to impede a free movement of the respective transmission structures in the light-stabilized dynamic material (LSDM) in its liquid state as little as possible.

In all embodiments of the drive components, the brake casing, the clutch casing, the converter casing, the transmission casing, the motor casing and/or another chamber in which the light-stabilized dynamic material (LSDM) is enclosed, may be provided with cooling ribs which extend outwards, or cooling channels in which a cooling liquid circulates can be formed in a chamber wall of the chamber or in a casing wall of the respective casing.

The cooling ribs and/or the cooling channels comprising the cooling liquid can be designed to discharge any undesired thermal energy quantity from the light-stabilized dynamic material (LSDM) to the outside.

The object is also achieved by a robot comprising a robot arm with multiple joints and multiple links which are adjustable relative to one another by the movements of the joints of the robot arm, wherein each driven joint is associated with a drive device according to one embodiment or according to several embodiments, as described inventively, and this respective drive device is designed to adjust the joint of the robot arm associated therewith, specifically by automatically controlling the motor of the respective drive device, wherein the control devices comprise a robot controller which is designed to automatically control the motors in order to automatically and individually adjust the links of the robot arm relative to one another by moving the joints in a driven manner.

Accordingly, the object can be achieved by a robot comprising a robot arm with multiple joints and multiple links which are adjustable relative to one another by the movements of the joints of the robot arm, wherein each driven joint is associated with a motor and at least one additional drive component from the group consisting of a transmission, a torque converter, a clutch and/or a brake, wherein the respective motor is designed to adjust the joint associated therewith, namely by automatically controlling the motor, and comprising a robot controller which is designed to automatically control the motors in order to automatically and individually adjust the links of the robot arm relative to one another by moving the joints in a driven manner, wherein the motor and/or the at least one additional drive component comprises a control means which changes the torque transmission and which comprises at least one illuminant, as described, and a material that influences the torque transmission, as described, and that comprises at least one light-stabilized dynamic material (LSDM), wherein the control means is configured to change the torque transmission by actuating the illuminant, which radiates onto the light-stabilized dynamic material (LSDM).

Specific embodiments of the invention are explained in more detail in the following descriptions with reference to the accompanying figures. Specific features of these embodiments, possibly considered individually or in further combinations, can represent general features of the invention, regardless of the specific context in which they are mentioned. The invention is described below with reference to the specific exemplary embodiment of a robot. As explained in the general part of the description, a single drive device or multiple drive devices can also be provided on other devices, machines and equipment which are not robots. In this respect, the features explained in the following description of the figures, which are not to be understood directly and exclusively as robot features, are to be understood as general features of the drive device which can also be used in conjunction with other devices, machines and equipment.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 is a schematic illustration of an exemplary robot comprising a robot arm and a robot controller, as well as associated drive components,

FIG. 2 is a schematic illustrated of an exemplary inventive drive component in the embodiment of a brake comprising a light-stabilized dynamic material,

FIG. 3 is a schematic illustration of an exemplary inventive drive component in the embodiment of a clutch comprising a light-stabilized dynamic material,

FIG. 4 is a schematic illustration of an exemplary inventive drive component in the embodiment of a torque converter comprising a light-stabilized dynamic material,

FIG. 5 is a schematic illustration of an exemplary inventive drive component in the embodiment of a transmission comprising a light-stabilized dynamic material, and

FIG. 6 is a schematic illustration of an exemplary inventive drive component in the embodiment of a motor comprising a light-stabilized dynamic material.

### DETAILED DESCRIPTION

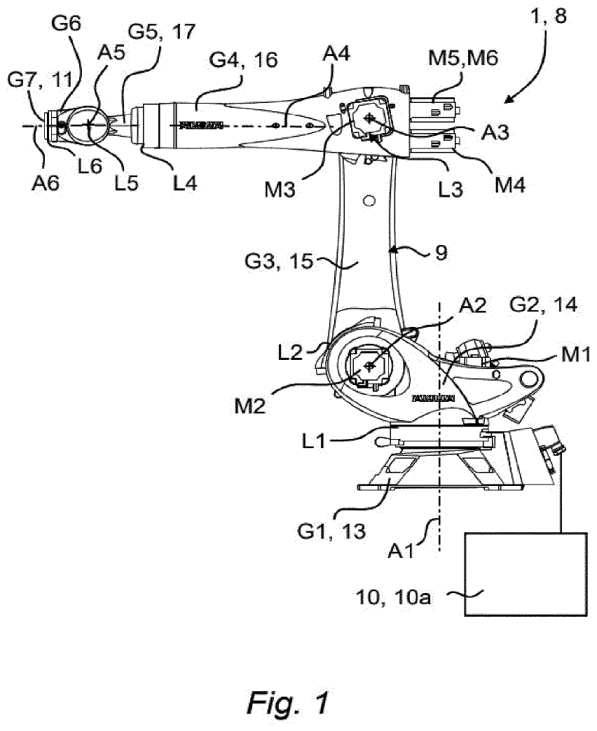

FIG. 1 shows a robot 8 which comprises a robot arm 9 and a control device 10a designed as a robot controller 10. In the case of the present exemplary embodiment, the robot arm 9 comprises several, successively arranged links G1 through G7 connected to one another by means of joints L1 through L6 so as to be able to rotate. In the case of the exemplary embodiment shown, the robot 8 comprises an associated drive device 1 for each joint L1 to L6.

The robot 8 has the robot controller 10, which is designed to execute a robot program and to move the links G1-G7 and joints L1-L6 of the robot arm 9 automatically. One of the several links G1-G7 forms an end link (G7) of the robot arm 9, which has a tool flange 11.

The robot controller 10 of the robot 8 is designed or configured to execute a robot program by which the links L1 to L6 of the robot arm 9 can be adjusted or moved in rotation in automated fashion or automatically in a manual mode in accordance with the robot program. For this purpose, the robot controller 10 is connected to controllable electric drives, the motors M1 through M6, which are designed to move the respective joints L1 through L6 of the robotic arm 9.

In the instance of the present exemplary embodiment, the links G1 through G7 are a robot base frame 13 and a carousel 14 which is borne so as to be rotatable, relative to the robot base frame 13, about a vertically traveling axis A1. Further elements of the robot arm 9 are a link arm 15, a boom arm 16, and a preferably multi-axis robot hand 17 with a fastening device designed as a tool flange 11 for fastening a tool. The link arm 15 is mounted at the lower end on the carousel 14, i.e., at the link L2 of the link arm 15, which can also be referred to as the pivot bearing head, so as to be pivotable about a preferably horizontal axis of rotation A2.

At the upper end of the link arm 15, the boom arm 16 is in turn mounted at the one link L3 of the link arm 15 so as to be pivotable about a likewise preferably horizontal axis A3. At its end, said boom arm supports the robot hand 17 with its preferably three axes of rotation A4, A5, A6. The joints L1 to L6 can be driven in a program-controlled manner by a respective one of the electric motors M1 to M6 via the robot controller 10, and can be braked and arrested in place by means of the brakes B1 to B6 associated with the joints L1 to L6 or the motors M1 to M6.

In the case of the robot arm 9, each driven joint L1-L6 is associated with a motor M1-M6 and at least one additional drive component 20 from the group of a transmission 25, a torque converter 24, a clutch 23 and/or a brake 22, wherein the motor M1-M6 and/or the at least one additional drive component 20 comprises a control means 21 which changes the torque transmission and which comprises at least one illuminant 21.1 and a material 21.2 that influences the torque transmission and that comprises at least one light-stabilized dynamic material LSDM, and wherein the control means 21 is configured to change the torque transmission by actuating the illuminant 21.1, which radiates onto the light-stabilized dynamic material LSDM.

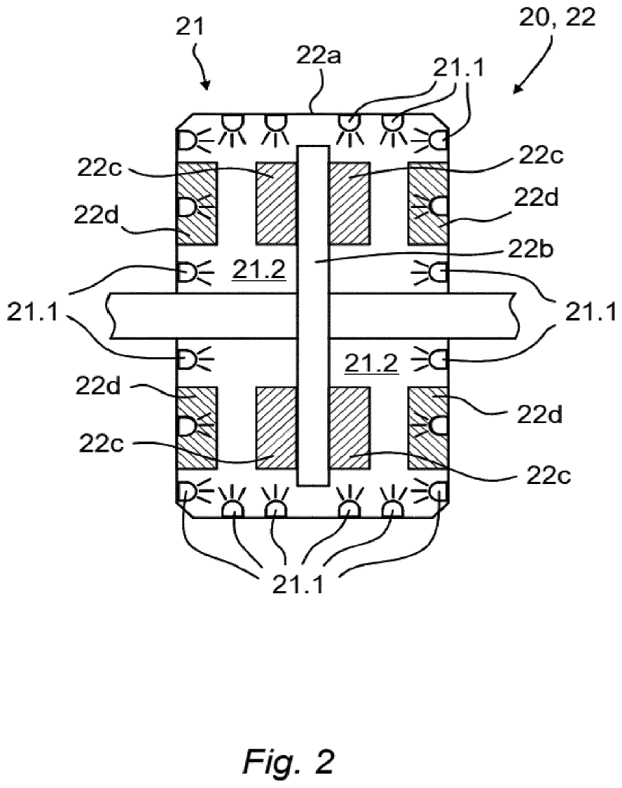

FIG. 2 shows an exemplary inventive drive component 20 in the first embodiment of a brake 22, wherein the control means 21 which changes the torque transmission is associated with at least one of the brakes 22 of the robot arm 9, wherein the respective brake 22 comprises a brake member 22b which is torque-coupled to the associated motor M1-M6, is rotatably mounted in a brake casing 22a of the brake 22 and comprises first brake transmission structures 22c, and the brake casing 22a comprises second brake transmission structures 22d, wherein the first brake transmission structures 22c are in contact with the second brake transmission structures 22d via the material 21.2 comprising the at least one light-stabilized dynamic material LSDM in order to control the torque transmission between the first brake transmission structures 22c and the second brake transmission structures 22d as a function of the light radiated by the illuminants 21.1 onto the light-stabilized dynamic material LSDM.

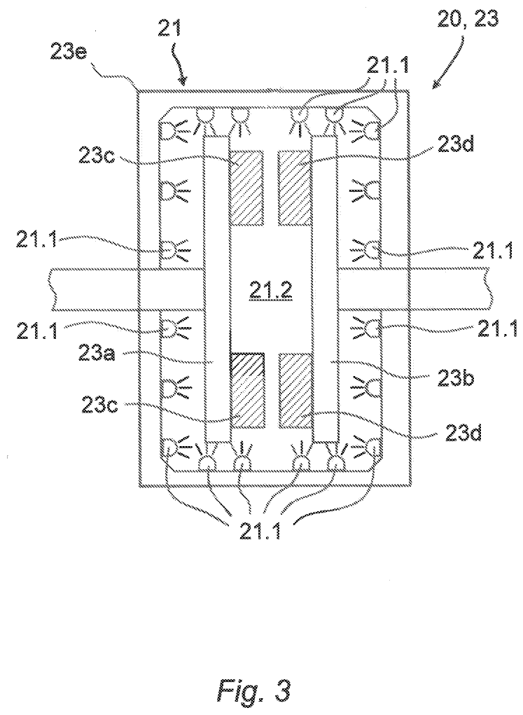

FIG. 3 shows an exemplary inventive drive component 20 in the second embodiment of a clutch 23, wherein the control means 21 which changes the torque transmission is associated with at least one clutch 23 of the robot 8, wherein the clutch 23 comprises a first clutch member 23a which is torque-coupled to the associated motor M1-M6, is rotatably mounted in a clutch casing 23e of the clutch 23 and comprises first clutch transmission structures 23c, and said clutch comprises a second clutch member 23b rotatably mounted in the clutch casing 23e of the clutch 23 and comprising second clutch transmission structures 23d, wherein the first clutch transmission structures 23c are in contact with the second clutch transmission structures 23d via the material 21.2 comprising the at least one light-stabilized dynamic material LSDM in order to control the torque transmission between the first clutch transmission structures 23c and the second clutch transmission structures 23d as a function of the light radiated by the illuminants 21.1 onto the light-stabilized dynamic material LSDM.

In the case of the first and second embodiments, as shown in FIG. 2 and FIG. 3, the illuminants 21.1 are arranged inside the brake casing 22a (FIG. 2) or inside the clutch casing 23e (FIG. 3) and are electrically actuated from outside of the brake casing 22a (FIG. 2) or the clutch casing 23e (FIG. 3).

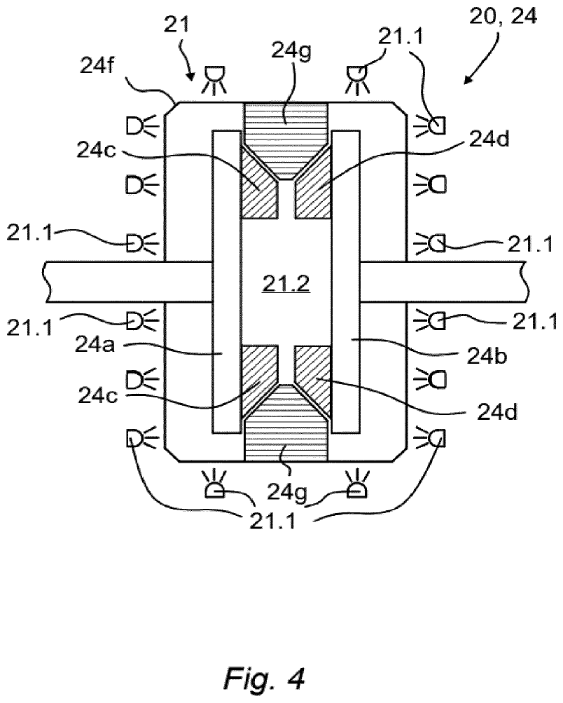

However, in the cases of the third to fifth embodiments, as shown in FIG. 4 to FIG. 6, the illuminants 21.1 can also be arranged, for example, inside the converter casing 24g, inside the transmission casing 25e and/or inside the motor casing 26e and can accordingly be electrically actuated from the outside.

FIG. 4 shows an exemplary inventive drive component 20 in the third embodiment of a torque converter 24, wherein the control means 21 which changes the torque transmission is associated with at least one torque converter 24 of the robot 8, and wherein the torque converter 24 comprises a first converter member 24a which is torque-coupled to the associated motor M1-M6, is rotatably mounted in a converter casing 24f of the torque converter 24 and comprises first converter transmission structures 24c, and said converter comprises a second converter member 24b rotatably mounted in the converter casing 24f of the torque converter 24 and comprising second converter transmission structures 24d, and the converter casing 24f comprises third converter transmission structures 24g, wherein the first converter transmission structures 24c are in contact with the second converter transmission structures 24d and third converter transmission structures 24g via the material 21.2 comprising the at least one light-stabilized dynamic material LSDM in order to control the torque transmission between the first converter transmission structures 24c and the second converter transmission structures 24d as a function of the light radiated by the illuminants 21.1 onto the light-stabilized dynamic material LSDM.

In the third embodiment according to FIG. 4, in a modification, the illuminants 21.1 are arranged outside of a light-transmissive converter casing 24f and the light emitted by the illuminants 21.1 is radiated onto the light-stabilized dynamic material LSDM from outside of the light-transmissive converter casing 24f.

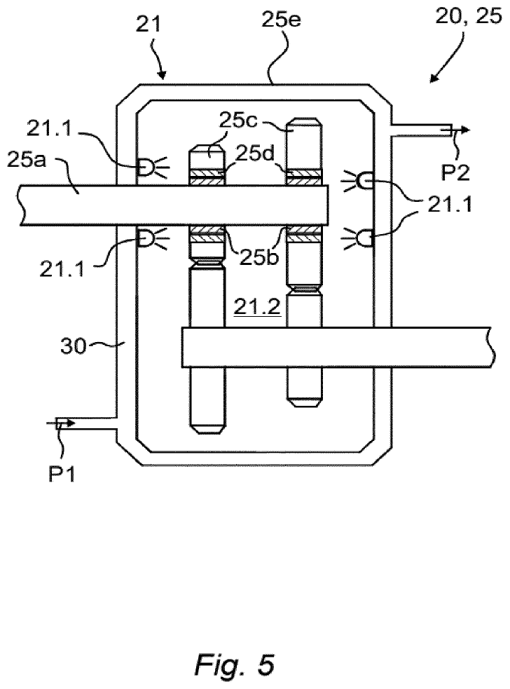

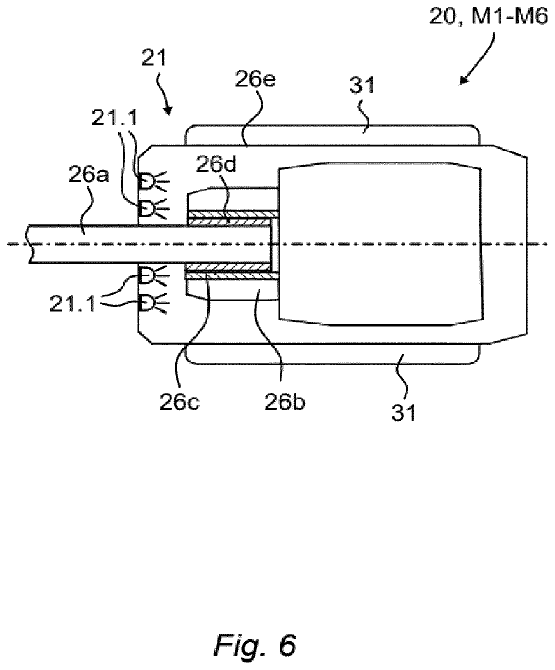

In the same sense, in the other embodiments according to FIG. 2, FIG. 3, as well as FIG. 5 and FIG. 6, the illuminants 21.1 can also be arranged outside of a light-transmissive brake casing 22a, outside of a light-transmissive clutch casing 23e, outside of a light-transmissive transmission casing 25e and/or outside of a light-transmissive motor casing 26e, wherein the light emitted by the illuminants 21.1 radiates onto the light-stabilized dynamic material LSDM from the outside.

FIG. 5 shows an exemplary inventive drive component 20 in the fourth embodiment of a transmission 25, wherein the control means 2 which changes the torque transmission is associated with at least one transmission 25 of the robot 8, and wherein the transmission 25 comprises a transmission member 25a which is torque-coupled to the associated motor M1-M6, is rotatably mounted in a transmission casing 25e of the transmission 25 and comprises first transmission structures 25b, and at least one transmission stage 25c comprising second transmission transmission structures 25d is arranged in the transmission casing 25e, wherein the first transmission structures 25b are in contact with the second transmission structures 25d via the material 21.2 comprising the at least one light-stabilized dynamic material LSDM in order to control the torque transmission between the first transmission structures 25b and the second transmission structures 25d as a function of the light radiated by the illuminants 21.1 onto the light-stabilized dynamic material LSDM.

In the fourth embodiment according to FIG. 5, the transmission casing 25e in which the light-stabilized dynamic material LSDM is enclosed is provided by way of example with a casing wall in which cooling channels 30 are formed, in which a cooling liquid circulates (arrows P1, P2).

In the other embodiments too, in deviation from the illustrations, the brake casing 22a, the clutch casing 23e, the converter casing 24f, the motor casing 26e and/or another chamber in which the light-stabilized dynamic material (LSDM) is enclosed, may comprise cooling channels 30 in which a cooling liquid circulates in a chamber wall of the chamber or in a casing wall of the respective casing.

FIG. 6 shows an exemplary inventive drive component 20 in the fifth embodiment of a motor M1-M6, wherein the control means 21 which changes the torque transmission is associated with at least one of the motors M1-M6, wherein the motor M1-M6 comprises a torque member 26b which is torque-coupled to the associated motor shaft 26a, is rotatable in a motor casing 26e of the motor M1-M6, and comprises first motor torque transmission structures 26c, and the motor shaft 26a comprises second motor torque transmission structures 26d, wherein the first motor torque transmission structures 26c are in contact with the second motor torque transmission structures 26d via the material 21.2 comprising the at least one light-stabilized dynamic material LSDM in order to control the torque transmission between the first motor torque transmission structures 26c and the second motor torque transmission structures 26d as a function of the light radiated by the illuminants 21.1 onto the light-stabilized dynamic material LSDM.

In the fifth embodiment according to FIG. 6, by way of example, the motor casing 26e is provided with cooling ribs 31 which extend outwards.

However, in the other embodiments, in deviation from the illustrations, the brake casing 22a, the clutch casing 23e, the converter casing 24f, the transmission casing 25e and/or another chamber, in which the light-stabilized dynamic material LSDM is enclosed, may also be provided with cooling ribs 31 which extend outwards.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

What is claimed is:

1-11. (canceled)

12. A drive device, comprising:
at least one motor;
at least one additional drive component coupled with the motor selected from the group of a transmission, a torque converter, a clutch, or a brake; and
a control device configured to automatically control the at least one motor;
wherein at least one of the at least one motor or the at least one additional drive component comprises a torque adjustment means that changes torque transmission of the drive device;
the torque adjustment means comprising:
at least one illuminant, and
a material that influences the torque transmission and that comprises at least one light-stabilized dynamic material (LSDM);
wherein the torque adjustment means is configured to change the torque transmission by actuating the illuminant, which then radiates onto the light-stabilized dynamic material (LSDM).

13. The drive device of claim 12, wherein:
the at least one additional drive component is at least one brake;
the torque adjustment means is associated with at least one of the brakes of the drive device;
the respectively associated brake comprises a brake member that is torque-coupled to the associated motor;
the respectively associated brake is rotatably mounted in a brake casing and comprises first brake transmission structures;
the brake casing comprises second brake transmission structures; and
the first brake transmission structures are in contact with the second brake transmission structures via the material, whereby torque transmission between the first brake transmission structures and the second brake transmission structures is controlled as a function of the light radiated by the illuminants onto the light-stabilized dynamic material (LSDM).

14. The drive device of claim 12, wherein:
the at least one additional drive component is at least one clutch;
the torque adjustment means is associated with the at least one clutch;
the at least one clutch comprises a first clutch member that is torque-coupled to the associated motor, is rotatably mounted in a clutch casing, and comprises first clutch transmission structures;
the at least one clutch further comprises a second clutch member rotatably mounted in the clutch casing and comprising second clutch transmission structures; and
the first clutch transmission structures are in contact with the second clutch transmission structures via the material, whereby torque transmission between the first clutch transmission structures and the second clutch transmission structures is controlled as a function of the light radiated by the illuminants onto the light-stabilized dynamic material (LSDM).

15. The drive of claim 12, wherein:
the at least one additional drive component is at least one torque converter;
the torque adjustment means is associated with the at least one torque converter;
the at least one torque converter comprises a first converter member which is torque-coupled to the associated motor, is rotatably mounted in a converter casing, and comprises first converter transmission structures;
the at least one torque converter further comprises a second converter member rotatably mounted in the converter casing and comprising second converter transmission structures;
the converter casing comprises third converter transmission structures; and
the first converter transmission structures are in contact with the second converter transmission structures and the third converter transmission structures via the material, WHEREBY torque transmission between the first converter transmission structures and the second converter transmission structures is controlled as a function of the light radiated by the illuminants onto the light-stabilized dynamic material (LSDM).

16. The drive device of claim 12, wherein:
the at least one additional drive component is at least one transmission;
the torque adjustment means is associated with the at least one transmission;
the transmission comprises a transmission member which is torque-coupled to the associated motor, is rotatably mounted in a transmission casing, and comprises first transmission structures;
at least one transmission stage comprising second transmission structures is arranged in the transmission casing; and
the first transmission structures are in contact with the second transmission structures via the material, whereby torque transmission between the first transmission structures and the second transmission transmission structures is controlled as a function of the light radiated by the illuminants onto the light-stabilized dynamic material (LSDM).

17. The drive device of claim 12, wherein:
the torque adjustment means is associated with the at least one motor;
the at least one motor comprises a torque member which is torque-coupled to the associated motor shaft, is rotatable in a motor casing, and comprises first motor torque transmission structures;
the motor shaft comprises second motor torque transmission structures; and
the first motor torque transmission structures are in contact with the second motor torque transmission structures via the material, whereby torque transmission between the first motor torque transmission structures and the second motor torque transmission structures is controlled as a function of the light radiated by the illuminants onto the light-stabilized dynamic material (LSDM).

18. The drive device of claim 12, wherein:
the at least one illuminant is at least one light emitting diode (LED);
the at least one LED is arranged inside at least one of the brake casing, the clutch casing, the converter casing, the transmission casing, or the motor casing; and
the at least one illuminant is electrically actuated from outside the respective casing.

19. The drive device of claim 12, wherein:
the at least one illuminant is at least one LED;
the at least one LED is arranged outside at least one of a light-transmissive brake casing, a light-transmissive clutch casing, a light-transmissive converter casing, a light-transmissive transmission casing, or a light-transmissive motor casing; and
light emitted by the at least one LED radiates onto the light-stabilized dynamic material (LSDM) from outside the respective casing.

20. The drive device of claim 12, wherein:
the at least one additional drive component comprises at least first and second transmission structures in contact with one another via the material, whereby torque transmission between the first transmission structures and the second transmission structures is controlled as a function of light radiated by the illuminants onto the light-stabilized dynamic material (LSDM); and
the at least first and second transmission structures comprise projections that extend into the light-stabilized dynamic material (LSDM).

21. The drive device of claim 20, wherein the projections are blade-shaped wave-shaped projections

22. The drive device of claim 12, wherein:
the at least one additional drive component comprises a casing that encloses the light-stabilized dynamic material (LSDM); and
the casing comprises:
outwardly extending cooling ribs, or
cooling channels formed in a casing wall and configured to circulate cooling liquid.

23. The drive device of claim 12, further comprising:
a chamber that encloses the light-stabilized dynamic material (LSDM);
the chamber comprising:
outwardly extending cooling ribs, or
cooling channels formed in a chamber wall and configured to circulate cooling liquid.

24. A robot, comprising:
a robot arm comprising multiple joints and multiple links which are adjustable relative to one another by movements of the of the respective joints; and
a plurality of drive devices in accordance with claim 12, each drive device operatively associated with a respective one of the joints, and controlling movement of the respective joint to thereby automatically and individually adjust the links relative to one another.
